(19) United States
(12) Patent Application Publication
(10) Pub. No.: US 2011/0311702 A1
(43) Pub. Date: Dec. 22, 2011

(54) PERCEPTIONAL CHARACTERISTICS OF BEVERAGES

(75) Inventors: Vince Cavallini, Inver Grove Heights, MN (US); Andres Del-Rosal, Plymouth, MN (US); Brian Guthrie, Chanhassen, MN (US); Joe Mize, St. Louis Park, MN (US); Bas Van Der Burgt, Hertogenbosch (NL)

(73) Assignee: CARGILL, INCORPORATED, Wayzata (MN)

(21) Appl. No.: 13/129,369

(22) PCT Filed: Nov. 13, 2009
(86) PCT No.: PCT/US09/64435

§ 371 Date: Sep. 8, 2011

(30) Foreign Application Priority Data
Nov. 14, 2008 (EP) PCT/EP2008/009673

(51) Int. Cl. A23L 2/56; A23L 1/29; A23L 1/22; A23L 2/52

(52) U.S. Cl. 426/548; 426/590; 426/592

(57) ABSTRACT

A method for improving the mouthfeel or flavor of beverages by adding hydrocolloids having a particular instrinsic viscosity, and reduced-calorie beverages comprising said hydrocolloids.

### CROSS REFERENCE TO RELATED APPLICATION

This application claims the benefit of the international application PCT/EP2008/009673, filed 14 Nov. 2008, entitled IMPROVING THE MOUTHFEEL OF BEVERAGES, which is hereby incorporated by reference herein in its entirety.

### TECHNICAL FIELD OF THE INVENTION

The present invention relates to the field of altering perceptional characteristics of beverages. In particular, the present invention relates to a method for improving the mouthfeel or flavor of beverages by adding hydrocolloids having a particular intrinsic viscosity.

### BACKGROUND OF THE INVENTION

Bodyweight concerns are of paramount importance to the world population; to react to this, food manufacturers are eager to reduce calories in beverages (e.g. “reduced calories”, “light beverages”, “calorie-reduced beverage” etc); however, these beverages often have a lower consumers' acceptance rate as they lack the mouthfeel, body and flavor of their regular equivalents (e.g. “equivalent full calorie beverages”). The addition of low calorie ingredients, such as, for example, a high intensity sweetener, which can partially or totally substitute high calorie ingredients, such as for example, a nutritive sweetener like sucrose, may accomplish a reduction in calories but presents an important challenge for the beverage industry. The challenge is to maintain the flavor, the mouthfeel and the body of the regular beverage, and thus generate a similar sensory response.

Thus, there is a long felt need in the industry to improve the perceptional characteristics of beverages, particularly of calorie-reduced beverages such as, for example, light beverages, where consumers' acceptance is often compromised by their lack of body, flavor or mouthfeel as compared to their full-calorie equivalents. A typical example of this problem exists in the carbonated beverage industry, where light drinks often lack acceptance for their difference in body and flavor as compared to full-calorie drinks.

In WO 2007/066233, novel oil phases for the preparation of beverage emulsions were disclosed. These oil-in-water emulsions were based on an oil phase having a density of 0.99 to 1.05 g/cm³ and a viscosity of 10 to 1500 cP (centipoises), an aqueous phase and pectin, and they were reported to show enhanced emulsifying properties and stability. However, only certain types of beverages can be prepared from such oil-in-water emulsions. In addition, no information on the mouthfeel properties of the final emulsion-based beverage is provided in this document.

So far, the research of improving the mouthfeel of beverages has mainly focused on density and viscosity. There remains a need to further improve the mouthfeel of beverages.

Similarly, attempts to improve the flavor of beverages has mainly focused on the mere addition of a high intensity sweetener to compensate for the reduction of the nutritive sweetener in the formulation. The resulting calorie-reduced beverage lacks mouthfeel, body and has a negative flavor impact with at least increases in bitterness and astringency. The present invention provides a method to improve the mouthfeel and flavor of beverages by adding a particular group of hydrocolloids.

### SUMMARY OF THE INVENTION

In one aspect, the invention relates to a method for improving the mouthfeel or flavor of beverages comprising the step of adding from about 10 to about 1500 ppm of one or more first hydrocolloids to said beverage, characterized in that the first hydrocolloids have an intrinsic viscosity of 5-600 mL/g as measured by capillary flow viscosimetry. In another aspect, the beverages of this method are calorie-reduced beverages in which at least a portion of a nutritive sweetener has been removed and a high intensity sweetener has been added. In a particular aspect, the high intensity sweetener is a rebaudioside A such as the Truvia™ brand sweetener available from Cargill, Incorporated.

In a further aspect, the present invention relates to a calorie-reduced beverage composition having a lubricity which is about equal or higher than the lubricity of its equivalent full calorie beverage, said calorie-reduced beverage composition comprising one or more first hydrocolloids having an intrinsic viscosity of 5 to 600 mL/g as measured by capillary flow viscosimetry. The calorie-reduced beverage composition may also be characterized as having less bitter or astringent flavor compared to an equivalent calorie-reduced beverage composition without one or more first hydrocolloids.

In yet another aspect, the present invention relates to the use of hydrocolloids for improving the mouthfeel or flavor of beverages.

### BRIEF DESCRIPTION OF THE DRAWINGS

FIG. 1 shows a spectrophotometric scan (0.1 nm bandwidth) of sugar beet pectin at a concentration of 174.9 μg/mL in 0.1M NaCl/0.02M acetate buffer.

FIG. 2 shows the Stribeck curves of a light and a regular non-carbonated Oasis® type beverage.

FIG. 3 shows the differential Stribeck curves of FIG. 2 with the determination of the maximum differential friction factor (Δμ)ₘₐₓ.

FIG. 4 shows the rheological & tribological mapping of non-carbonated Oasis® type beverages (regular and beverages spiked with 600 ppm hydrocolloids) versus light beverage reference (CMC=carboxymethyl cellulose).

FIG. 5 shows the rheological & tribological mapping of carbonated Fanta®-type beverages (regular beverage and light beverages spiked with 50, 150, 300, 600, 800 and 1,000 ppm sugarbeet pectin) versus light beverage reference.

FIG. 6 shows a tribological measurement of Fanta®, Fanta Light® and Fanta Light® with increasing concentrations of sugar beet pectin.

FIG. 7 shows the Stribeck curves of a regular, calorie-reduced and modified calorie-reduced carbonated lemon lime type beverage.

### DETAILED DESCRIPTION

### I. Introduction

To better understand the present invention, it is useful to have at least a general knowledge of certain concepts and terminology related to taste and taste modification. First, taste is often referred to as a taste quality, which is selected from bitter, sweet, sour, salty and umami. It is possible to have one or more of these taste qualities within the same item. Taste modification often involves either an enhancement or synergy, or a suppression or masking of a particular taste quality. Taste modification may also involve a change in the duration (or time) and intensity of the taste quality. Thus, in a visual sense, a curve of a taste profile can be shifted forward or backward in time, be lengthened or shortened (duration) and certain peaks can be decreased or increased in height (intensity).

Furthermore, the senses of taste and smell (or odor) are anatomically two separate entities. Taste is stimulated through physical interactions of non-volatile molecules with receptors on the tongue and mouth surfaces, while volatile compounds reaching the receptors in the olfactory epithelium determine smell. At a perceptual level, however, there are many indications that the sensations of taste and smell, interact. Interactions may also occur with the other modalities of appearance, sound and texture.

The multimodal interaction and integration of these sensations results in a complex perception that is commonly called “flavor.” Thus, unless a person is aguesic (those who perceive no tastes) or anosmic (those who cannot perceive odors), the consumption of foods and beverages results in the simultaneous perception of taste and smell, for example, which contributes to an overall impression of flavor.

### II. Abbreviations and Terms

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more of these stated alternative elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Definitions of common terms in chemistry may be found in Richard J. Lewis, Sr. (ed.), Hawley's Condensed Chemical Dictionary, published by John Wiley & Sons, Inc., 1997 (ISBN 0-471-29205-2).

Explanations of certain, specific terms are provided below or generally within the text of the application.

The term “body” according to the present invention is the richness of flavor or impression of consistency given by a beverage.

The term “mouthfeel” of a beverage according to the present invention is the tactile sensations perceived at the lining of the mouth, including the tongue, gums and teeth.

The term “bitter” is the most sensitive of the tastes, and is perceived by many to be unpleasant, sharp, or disagreeable. Common bitter foods and beverages include coffee, unsweetened cocoa, South American “mate”, marmalade, bitter melon, beer, bitters, olives, citrus peel, many plants in the Brassicaceae family, dandelion greens and escarole. Quinine is also known for its bitter taste and is found in tonic water.

The term “astringency” refers to the astringent sensations of dry, rough, harsh (especially for wine), tart (normally referring to sourness), rubbery, hard or styptic. Some foods, such as unripe fruits, contain tannins or calcium oxalate that cause an astringent or rough sensation of the mucous membrane of the mouth or the teeth. Examples include tea, red wine, rhubarb and unripe persimmons and bananas.

The term “beverage”, as used herein, means a drinkable composition. Beverages include, but are not limited to the following: carbonated and non-carbonated, alcoholic and non-alcoholic drinks including but not limited to carbonated water, flavored water, carbonated flavored water, drinks containing juice (juice derived from any fruit or any combination of fruits, juice derived from any vegetable or any combination of vegetables) or nectar, milk obtained from animals, milk product derived from soy, rice, coconut or other plant material, sports drinks, vitamin enhanced sports drinks, high electrolyte sports drinks, highly caffeinated high energy drinks, coffee, decaffeinated coffee, tea, tea derived from fruit products, tea derived from herb products, decaffeinated tea, wine, champagne, malt liquor, rum, gin, vodka, other hard liquors, beer, reduced calorie beer-type beverages, non-alcoholic beer, and other beer-type beverages obtained from a cereal solution such as beer, ale, stout, lager, porter, low alcoholic beer, alcohol-free beer, kvass, rye-bread beer, shandy, malt drinks and the like. Cereal in this context refers to grains commonly used to make the beverages listed above and other similar beverages. However, the term “beverage” excludes 100% juice based-beverages.

### III. Perceptional Characteristics

In one aspect of the present invention, the inventors developed a method for improving the perceptional characteristics of beverages such as mouthfeel or flavor, which comprises the step of adding one or more hydrocolloids (“first hydrocolloids”) with particular intrinsic viscosity to the beverage composition. By “adding” it is meant that if a beverage already contains hydrocolloids, its mouthfeel or flavor can be improved by adding, in addition, further hydrocolloid. The present invention reports methods for modifying and/or improving the mouthfeel and flavor of beverages by adding hydrocolloids having a particular instrinsic viscosity. For example, in one embodiment from about 10 to about 1500 ppm of one or more first hydrocolloids is added to a beverage. In this embodiment, the first hydrocolloids have an intrinsic viscosity of from about 10 to about 450 mL/g as measured by capillary flow viscosimetry. In this embodiment the beverage is a reduced calorie beverage in which at least one high intensity sweetener (e.g. rebaudioside A) has been added to compensate for the reduction of a nutritive sweetener present in the equivalent, full calorie beverage. Determination of the amount and type of the high intensity sweetener will vary based on the type of beverage and would be within the capacity of one of skill on the art. The first hydrocolloids provide an increase in mouthfeel. Surprisingly, there is also an increase in flavor perception and intensity as well as a reduction, if not an elimination depending upon usage level and type of the hydrocolloid) of bitterness and astringency. In this aspect, the hydrocolloid may actually perform a dual function in that it both enhances mouthfeel and flavor of the beverage by masking the bitter quality of the HIS. Thus, in another embodiment a reduced calorie beverage is provided that includes a HIS and a first hydrocolloid, wherein the beverage has an improved mouthfeel and flavor compared to a reduced calorie beverage that doesn't contain a first hydrocolloid.

The present invention also allows for an improved mouthfeel without affecting the organoleptic characteristics in such a way that the beverage would be assessed as unpleasantly thick or sticky. This improved mouthfeel can be examined best by a taste panel consuming said beverage in comparison to an equivalent beverage without the ingredient to be examined; or using a tribological device (see below). The term high intensity sweetener (HIS) as used herein means, generally, any sweetener found in nature which may be in raw, extracted, purified, or any other form, singularly or in combination thereof and characteristically have a sweetness potency greater than sucrose (common table sugar) yet have comparatively less calories. Even if the HIS has the same number of calories as sucrose, the usage amount of HIS is considerably less than sucrose thereby reducing the total calorie amount. For instance, because HISs are compounds having a sweetness that is many times that of sucrose, much less HIS is required to obtain a similar effect as sucrose and energy contribution is therefore negligible.

Non-limiting examples of HISs suitable for embodiments of the present invention include rebaudioside A, rebaudioside B, rebaudioside C, rebaudioside D, rebaudioside E, rebaudioside F, dulcoside A, dulcoside B, rubusoside, stevia, stevioside, mogroside IV, and mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, and cyclocarioside I, sodium saccharin, cyclamate, aspartame, acesulfame potassium, sucralose, alitame, neotame, neohesperidin dyhydrochalone (NHDC) and combinations thereof HISs also include modified HISs. Modified HISs include HISs which have been altered naturally. For example, a modified HIS includes, but is not limited to, HISs which have been fermented, contacted with enzyme, or derivatized or substituted on the HIS.

Steviol glycosides refer collectively to the terpene glycosides responsible for the sweet taste of the leaves of the stevia plant, a shrub in the chrysanthemum family native to Paraguay. Stevia rebaudiana is best known for its sweetness, although the genus includes other members (e.g., S. eupatoria, S. ovata, S plummerae, S. rebaudiana, S. salicifolia, and S. serrata), which may also produce sweet tasting glycosides. Stevia products have been used as sweeteners throughout the world for decades. Particular stevia compounds range in sweetness from 40 to 300 times that of sucrose, are heat and pH stable, do not ferment, and do not induce a glycemic response when ingested by mammals. Some of these latter features make them attractive for use as natural sweeteners for diabetics and other people on carbohydrate-controlled diets.

Major steviol glycosides and their approximate relative amounts include stevioside (5-10%), rebaudioside A (2-4%), rebaudioside C (1-2%), and dulcoside A (0.5-1%), as well as rebaudioside B, rebaudioside D, rebaudioside E, rebaudioside F, dulcoside B, and rubusoside. Many of these steviol glycosides, whether isolated from stevia plants, isolated from other plants, or chemically synthesized, can be used as a HIS.

In one embodiment, extracts of HISs may be used in any purity percentage. In another embodiment, when a HIS is used as a non-extract, the purity of the HIS may range for example from about 25% to about 100%. In another example, the purity of the HIS may range from about 70% to about 100%; from about 80% to about 90%; from about 90% to about 100%; from about 95% to about 100%; from about 96% to about 99%; from about 97% to about 98%; from about 98% to about 99%; and from about 99% to about 100%. Purity as used herein refers to a purity of a single type of HIS.

Purity, as used herein, represents the weight percentage of a respective HIS compound present in a HIS extract, in raw or purified form. In one embodiment, a steviolglycoside extract comprises a particular steviolglycoside in a particular purity, with the remainder of the stevioglycoside extract comprising a mixture of other steviolglycosides.

To obtain a particularly pure extract of a HIS, such as rebaudioside A, it may be necessary to purify the crude extract to a substantially pure form. Such methods generally are known to those of ordinary skill in the art. An exemplary method for purifying a HIS such as rebaudioside A, is described in U.S. provisional patent application Nos. 60/881,798 and 61/008,163, the disclosures of which are incorporated herein by reference in their entirety.

A steviol glycoside of particular interest is rebaudioside A. It has a sweetness that it several hundred times that of sucrose. Thus, in one embodiment of the present invention the HIS is rebaudioside A in a purity greater than about 97% rebaudioside A by weight on a dry basis. In another embodiment of the present invention, the HIS is rebaudioside A in a purity greater than about 90% rebaudioside A by weight on a dry basis. In still another embodiment, the HIS is rebaudioside A in a purity greater than about 80% rebaudioside A by weight on a dry basis.

The Lo Han Kuo (also known as Lo Han Guo) fruit (Siraitia grosvenori) is another plant containing terpene glycosides that have been used as sweeteners. Among these compounds are mogrosides I, mogrosides II, mogrosides III, mogrosides IV (esgoside), mogrosides V, siamenoside, and neomogroside. Collectively, these compounds are about 300 times as sweet as sucrose, although individual compounds are even sweeter.

The high intensity sweetener may also be a non-saccharide artificial sweetener, such as aspartame, sucralose, sodium saccharin, cyclamate, alitame, glycyrrhizin, neotame, NHDC and potassium acesulfame. Such sweeteners are non-caloric or low-caloric at levels used to adequately sweeten food (because they are so potent) their caloric amount is negligible, making them well suited for food products targeted at diabetics and people and animals on controlled carbohydrate diets. Other high intensity sweeteners included but are not limited to monatin and its salts (i.e., monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, cyclocarioside I, and combinations thereof.

The particular HIS (or combination of HISs) selected depends on the characteristics desired in the resulting sweetener. Where a “natural,” sweetener is desired, possible HISs plant glycosides and other compounds that occur in nature and have a sweet quality with or without caloric value. Where a non-natural HIS can be used, aspartame, saccharin, or other synthetic sweeteners may be used.

HISs for use in the present invention may have characteristics that make them undesirable for use on its (their) own. For example, the HIS may have a bitter taste, astringent taste or aftertaste, a sweetness that is slower, or a sweetness that is different in duration than known palatable sweeteners, such as sucrose. The HIS may also have a sweet quality that is slower in intensity and longer in duration compared to sucrose.

Preferably, the first hydrocolloids may be chosen from the group consisting of sugar beet pectin, apple pectin, citrus pectin, gum Arabic, nOSA (n-octenyl succinic anhydride) maltodextrin, low molecular weight carboxymethylcellulose (having an intrinsic viscosity <600 mL/g as measured by capillary flow viscosimetry) and mixtures thereof. Without wishing to be bound by theory, it is believed that the first hydrocolloid acts as a lubricant. The lubricating effect of the first hydrocolloid results in a fluid-like cushion that can sustain pressure created inside the mouth cavity during swallowing. Hence, friction forces between the tongue, the gums teeth and the palate are reduced. Such lubricating effect can be measured for example via the tribology device, which is explained herein below.

The method for improving the mouthfeel or flavor of beverages uses one or more first hydrocolloids having an intrinsic viscosity of from 5 to 600 mL/g as measured by capillary flow viscometry, preferably from 5 to 550 mL/g, more preferably from 10 to 500 mL/g, even more preferably from 10 to 450 mL/g, even more preferably from 50 to 450 mL/g, and most preferably from 100 to 450 mL/g.

Said first hydrocolloid(s) may be included in an amount of from about 10 to about 1500 ppm of the finally obtained beverage. More preferably, the amount of hydrocolloid(s) is from about 20 ppm to about 1300 ppm, more preferably from about 100 ppm to about 1000 ppm, and even more preferably from about 120 ppm to about 800 ppm and most preferably the amount is from 260 ppm to 800 ppm of the final beverage composition.

In a further preferred embodiment, the method for improving the mouthfeel or flavor of beverages also involves other edible substances that enable a positive modification of the body. Such positive modification can be obtained through modifying the viscosity and/or the osmolality of the beverage. The viscosity of the beverage influences the impression of consistency of the beverage, while osmolality affects the richness sensation of the beverage. As such, modifying viscosity and osmolality further contribute to the improved mouthfeel or flavor of the beverage. These edible substances are preferably chosen from the group consisting of other hydrocolloids (“second hydrocolloid”) or bulking agents and mixtures thereof.

When the mouthfeel, flavor or body needs to be fine-tuned, the edible substance (second hydrocolloid or bulking agent) is added in a quantity suitable to match the body of the target beverage. Preferably, the mouthfeel, flavor or body modifying substance is added in order to obtain an increase of viscosity below 0.4 mPa·s (at 20° C.), preferably an increase of 0.1 to 0.4 mPa·s (at 20° C.). The viscosity can be measured with an Anton Paar MCR300 rheometer (cylinder, CC24 probe) at a constant shear rate of 25 s⁻¹ at 20° C.

These second hydrocolloids may be, for example, guar gum, locust bean gum, cassia gum, pectin from other botanical sources (e.g. soy, potato), high molecular weight carboxymethylcellulose (having an intrinsic viscosity >600 mL/g, preferably >700 mL/g as measured by capillary flow viscosimetry), carrageenan, alginate or xanthane and mixtures thereof. The second hydrocolloid is different from the first hydrocolloid (providing the lubricating effect). The second hydrocolloid may be included in an amount of from about 10 to about 500 ppm, preferably from about 20 to about 450 ppm, and most preferably from about 30 to about 400 ppm.

Bulking agents may be chosen from the group consisting of isomaltulose, polydextrose, trehalose, erythritol or oligodextrans and mixtures thereof. The bulking agent may be included in an amount of from about 100 to about 12000 ppm, preferably from about 200 to about 11000 ppm, and most preferably from about 300 to about 10000 ppm.

Preferably the ratio of first hydrocolloid(s) to edible substance is from about 150:1 to about 1:1200, preferably from about 75:1 to about 1:600, and more preferably from about 40:1 to about 1:400. If the edible substance only comprises a second hydrocolloid, the ratio of first hydrocolloid to second hydrocolloid is from about 150:1 to about 1:50, preferably from about 75:1 to about 1:45, more preferably from about 40:1 to about 1:20, even more preferably from about 50:1 to about 1:20 and most preferably from about 40:1 to about 1:15. If the other edible substance only comprises bulking agent, the ratio of (lubrifying) hydrocolloid to bulking agent is from about 15:1 to about 1:1200, preferably from about 7:1 to about 1:600, more preferably from about 3:1 to about 1:400.

In a particularly preferred embodiment, the inventive composition for improving the mouthfeel or flavor of the beverage comprises sugar beet pectin alone or in combination with pectin from other sources such as apple pomace or citrus pulp, guar gum or mixtures thereof. The attractiveness of sugar beet pectin is not only based on its favorable price, but also on its ability to add body to the beverage without affecting the flavor or generating an unpleasant organoleptic impression. Thus in a particularly preferred embodiment of the present invention, the hydrocolloids added for improving the mouthfeel or flavor is sugar beet pectin.

In another particularly preferred embodiment, the inventive composition for improving the mouthfeel or flavor comprises gum Arabic alone or in combination with guar gum, citrus pectin, high molecular weight carboxymethylcellulose or mixtures thereof. Most preferably the composition comprises a mixture of gum Arabic and guar gum.

In yet another particularly preferred embodiment, the inventive composition for improving the mouthfeel or flavor comprises apple pectin alone or in combination with citrus pectin, guar gum or mixtures thereof. Most preferably the composition comprises a mixture of apple pectin and citrus pectin.

In still another particularly preferred embodiment, the inventive composition for improving the mouthfeel or flavor comprises citrus pectin alone or in combination with apple pectin, guar gum or mixtures thereof. Most preferably the composition comprises citrus pectin.

In yet another particularly preferred embodiment, the inventive composition for improving the mouthfeel or flavor comprises nOSA maltodextrin alone or in combination with guar gum.

In yet another particularly preferred embodiment, the inventive composition for improving the mouthfeel or flavor comprises low molecular weight carboxymethylcellulose (having an intrinsic viscosity <600 mL/g as measured by capillary flow viscosimetry) alone or in combination with guar gum.

According to one embodiment of the present invention, the method for improving the mouthfeel or flavor is used to improve the mouthfeel or flavor of a calorie-reduced beverage; the calorie reduction may be from 1 to 100% reduction of the calorific value of the beverage; preferably from 30 to 100%, more preferably from 50 to 100%, most preferably from 80 to 100%. Such a calorie-reduced beverage could be a “light beverage” or “zero calorie beverage”, as they are commonly known in the market. In case of such calorie-reduced beverages, the improved mouthfeel or flavor can be assessed in comparison to an equivalent full calorie beverage or “regular” equivalent. Ideally, the mouthfeel or flavor of the calorie-reduced beverage containing the mouthfeel or flavor enhancer resembles the mouthfeel or flavor of the corresponding regular equivalent.

Thus, in a further aspect of the present invention, the beverage is a calorie-reduced beverage in which at least a portion of a nutritive sweetener has been removed compared to its equivalent full calorie beverage (e.g. lowering sugar content by about half to reduce calorie content by about 25%) and a high intensity sweetener has been added to the calorie-reduced beverage. As such, the calorie-reduced beverage of the present invention has an improved flavor (e.g. reduced bitterness, reduced astringency, increased sweetness) compared to its equivalent full calorie beverage. The improved flavor can be best examined by a taste panel consuming said beverage in comparison to the same beverage without the ingredient to be examined.

In order to improve the mouthfeel or flavor of a calorie-reduced beverage, its lubricity is preferably about equal to or higher than its equivalent full calorie beverage. Preferably, the viscosity of the calorie-reduced beverage should be about equal to the viscosity of its equivalent full calorie beverage. With the term “equal” it is meant that there is a difference within 5%, preferably within 3%, even more preferably within 1%.

According to one embodiment of the present invention, the method for improving the mouthfeel or flavor could also be used to improve the mouthfeel or flavor of a carbonated and/or non-carbonated beverage. This beverage could be a full calorie beverage or a calorie-reduced beverage.

According to one embodiment of the present invention, the method for improving the mouthfeel or flavor could also be used to improve the mouthfeel or flavor of alcoholic beverages. In particular, these alcoholic beverages could be calorie-reduced beverages such as “light beverages” (e.g. malternatives). Alternatively, the beverage could also be a non-alcoholic beverage.

In the prior art, the mouthfeel properties of a beverage had to be tested by a taste panel as there were no measuring tools which could reliably examine the mouthfeel behaviour of a low viscosity liquid. The current technology in rheology is not sensitive enough to be used as a tool for screening mouthfeel-enhancing ingredients for low viscosity beverages. In particular, for low viscosity systems such as carbonated soft-drinks, non-carbonated soft drinks, flavored-water, beer, or fruit juice drinks the mouthfeel is influenced also by other forces than the viscosity, such as the lubrication. Most recently, Cargill Global Food Research has developed a tribometer that can be used as a screening tool and method for beverages and other low viscosity systems, see PCT/EP2008/004443 (published as WO 2008/148536) and PCT/EP2008/004446 (published as WO2008/148538) incorporated herein by reference. With this tribological device, it is possible to assess the influence of ingredients on the mouthfeel sensations, which are dependent on the overall texture of the beverage and its physical and chemical interactions in the mouth in combination with a standard rheometer.

In another aspect the present invention is directed to a calorie-reduced beverage composition having a lubricity which is about the same or higher than the lubricity of its equivalent full calorie beverage, said calorie-reduced beverage composition comprising one or more first hydrocolloids having an intrinsic viscosity of about 5 to about 600 mL/g as measured by capillary flow viscosimetry. Preferred ranges for intrinsic viscosity are those defined herein before. Preferred first hydrocolloids are those defined hereinbefore.

In a preferred embodiment, the calorie-reduced beverage composition further has a viscosity about equal to or higher than the viscosity of its equivalent full calorie beverage, said calorie-reduced beverage composition comprising one or more edible substances selected from the group of second hydrocolloids, bulking agents or mixtures, provided that the second hydrocolloid is different from the first hydrocolloid. Preferred edible substances and ratio of first hydrocolloids to edible substances are those as defined hereinbefore.

In yet another aspect the present invention is directed to a carbonated and/or a non-carbonated-type beverage composition which comprises hydrocolloids having an intrinsic viscosity of 5-600 mL/g as measured by capillary flow viscometry. In particular, the hydrocolloid added to the carbonated-type beverage composition can comprise sugar beet pectin, apple pectin, citrus pectin, gum Arabic, nOSA maltodextrin, low molecular weight carboxymethylcellulose (having an intrinsic viscosity <600 mL/g as measured by capillary flow viscosimetry) or mixtures thereof. Preferred edible substances and ratios of first hydrocolloids to edible substances are those as defined hereinbefore.

The first hydrocolloid (e.g. sugar beet pectin) preferably added to the carbonated-type beverage composition can be added in any amount, depending on the desired alteration of the mouthfeel or flavor. Preferably it is included in an amount of up to about 1500 ppm of the finally obtained beverage, more preferably, from about 100 ppm to about 1000 ppm. The mouthfeel improvement according to the present invention may be measured by tribology as being a decrease of the maximum differential friction factor (Δμ)max of at least 0.08, preferably 0.10 and more preferably 0.12. For example, good results have been obtained for a carbonated-type beverage composition and a non-carbonated beverage composition wherein the amount of sugar beet pectin added is 600 ppm of the final beverage composition.

The present invention is further illustrated by the examples provided below. It is understood that there examples are not intended to limit the scope of the present invention in any way.

### EXAMPLES

### Example 1

### Oasis® Type Non-Carbonated Beverages

### 1.1 Characterisation of Ingredients by Capillary Flow Viscometer

The flow time, dynamic viscosity, relative viscosity, specific viscosity, reduced viscosity and intrinsic viscosity at 25.00° C. were measured and calculated in 0.1M NaCl/0.02M acetate (pH 5.5, ionic strength □=0.111), at eight different concentrations (0.002 to 0.020 g/mL) for each ingredient. Samples were allowed to hydrate overnight and were filtered through a Schott glass filter (10 . . . 100 □m).

Ubbelohde viscometer (Schott-Gerate) with capillaries 532 10 (constant K=0.01018 mm²/s²) and 532 13 (constant K=0.02917 mm²/s²) were employed. 15 mL of solution was filled (after 2 successive rinses) and conditioned at 25.00° C. for at least 15 minutes prior flow time measurement (in triplicate) with the ViscoClock (Schott-Geräte). Averaged flow times were then corrected using Hagenbach correction tables provided by the manufacturer.

The density of the filtered solution was measured by pycnometry (10 mL capacity pycnometers) at 25.00° C.

Table 1 tabulates the intrinsic viscosity [η], calculated from the classical 3 extrapolations (Huggins, Kraemer and single point) as follows:

[η] is the intercept (when concentration c=0) of the equations:
Huggins ηₛₚ/c=[η]+k′[η]²c
Kraemer (ln ηᵣₑₗ)/c=[η]+k″[η]²c
Single-point [η]={2(ηₛₚ−ln ηᵣₑₗ)}^{1/2}/c

TABLE 1
Data from capillary flow viscometer

| | [η] |
|---|---|
| | (mL/g) |
| gum arabic Ultra VM | 19.8 |
| (from Caldic Belgium N.V., Hemiksem, Belgium) | |
| nOSA maltodextrin C*Form 12672 | 20.1 |
| (from Cargill, Haubourdin, France) | |
| sugar beet pectin Stal 1493 | 179 |
| (Cargill, Redon, France) | |
| Low molecular weight carboxymethylcellulose | 303 |
| Cekol 30 (CP Kelco B.V., Nijmegen, the Netherlands) | |
| Apple pectin (Cargill, Redon, France) | 532 |

### 1.2 Characterisation of Sugar Beet Pectin by Spectrophotometry

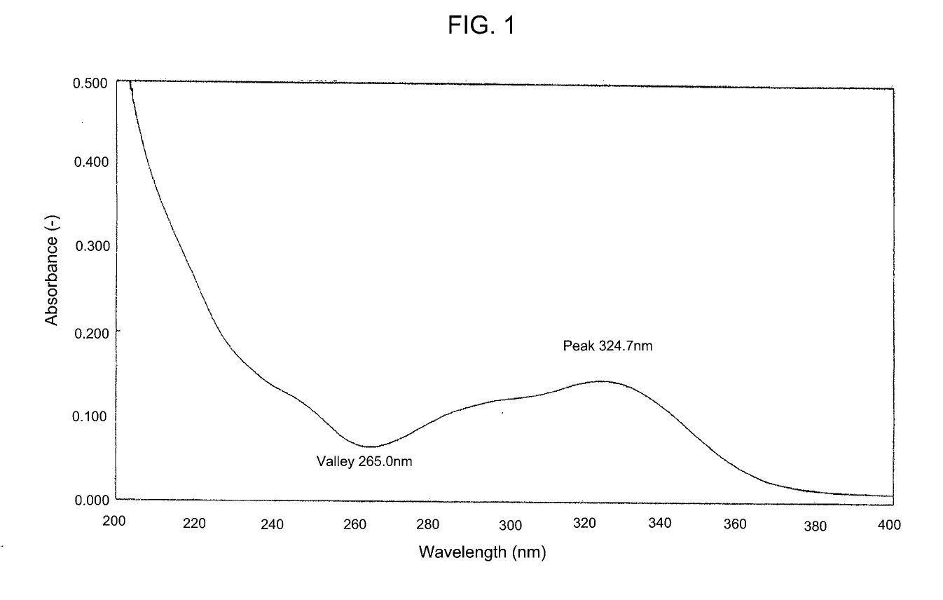

FIG. 1 show the UV/visible scan (0.1 nm bandwidth) of sugarbeet pectin (174.9 μg/mL in 0.1M NaCl/0.02M acetate) recorded with a double beam Perkin-Elmer Lambda 650 spectrophotometer using 10,00 mm quartz cuvettes (Suprasil®, Hellma 100-QS).

Spectrophotometric accuracy was checked with acidified potassium dichromate. Wavelength and spectral resolution were checked with holmium oxide filter. Stray light was checked with low bromide KCl solution.

### 1.3 Composition of Oasis® Type Non-Carbonated Beverages

The Oasis® type non-carbonated beverages have the following composition:

Regular beverage: water, juices from concentrate 15% (orange, apple), sugar, acidity regulator E330 (citric acid), aromas, preserver E211 (sodium benzoate), stabiliser E412 (guar gum), antioxidant E300 (ascorbic acid).

9% sugar added

Light beverage: water, juices from concentrate 15% (orange, apple), acidity regulator E330 (citric acid), tested ingredient, high intensity sweeteners (acesulfame K, Aspartame), aromas, preserver E211 (sodiumbenzoate), 0% sugar added

### 1.4 Friction Profile of Oasis® Type Non-Carbonated Beverages by Tribology

All tribology measurements were carried out on a MCR-301 rheometer (Anton Paar, Stuttgart, Germany) using a tribology device with a measuring system of the ball-on-three-plates geometry, which was temperature controlled by a Peltier and hood temperature control system. This tribology device employs stainless steel ball which is rotated over a contact area comprising 3 grooves, where 3 interchangeable strips of substrates are placed. The substrates are made of a thermoplastic elastomer (HTF 8654-94, available from KRAIBURG TPE GmbH, Waldkraiburg, Austria).

The test temperature was set at 20° C. with an initial non-recording pre-shear of 0.4 mm/s for 10 minutes followed by recording the friction coefficient as a function of sliding speed (0.4 to 250 mm/s) at constant load of 3 N. The friction force F_{R} is measured as a function of sliding speed. The friction factor or coefficient g was calculated as the ratio of friction force to normal force F_{R}/F_{N}.

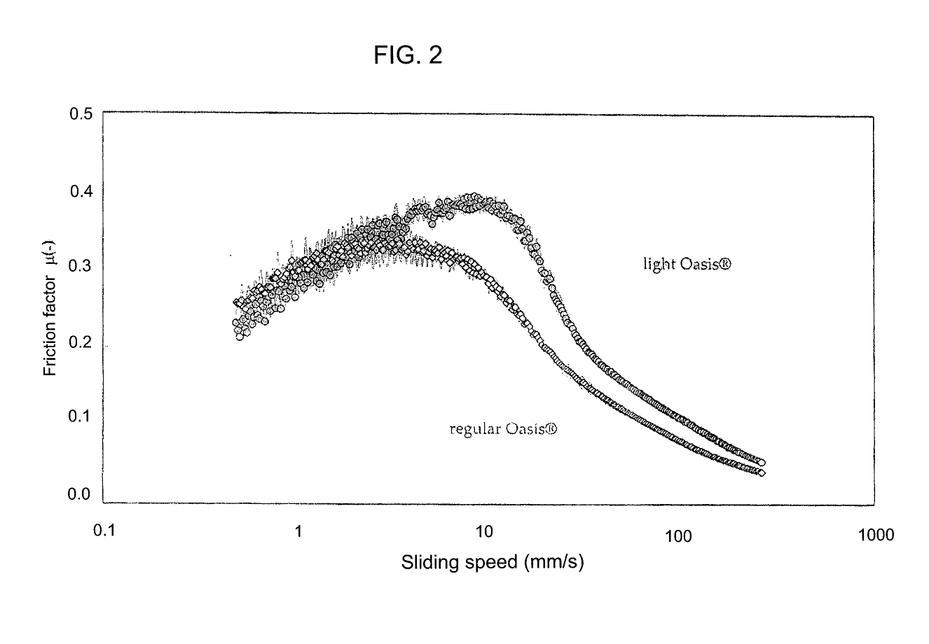

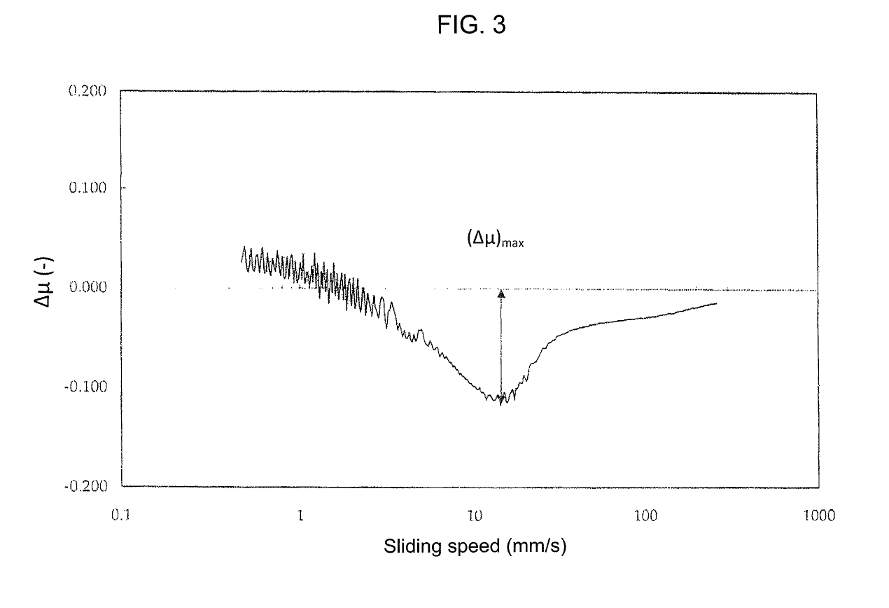

FIG. 2 show the friction profile (Stribeck curve) of a light and a regular Oasis® type beverage. FIG. 3 show the differential friction profile of a light and a regular Oasis-type beverage and the calculation of the maximum differential friction factor (Δμ)ₘₐₓ.

### 1.5 Sensory Analysis (Mouthfeel), Rheology & Tribology of Oasis-Type Non-Carbonated Beverages

Oasis® type non-carbonated beverages were prepared with hydrocolloids levels of 100, 600 and 1,000 ppm. Ranking test by trained panelists (n=3) focusing on mouthfeel perception were performed using regular Oasis as reference. Table 2 tabulates sensory scores of the beverages ranking the hydrocolloids by potency for mouthfeel perception.

TABLE 2
Sensory analysis mouthfeel data

| Hydrocolloids potency | Sensory Score (ranking) |
|---|---|
| 1. Sugarbeet Pectin | 100 ppm < 600 ppm ~ regular < 1,000 ppm |
| 2. Gum Arabic | 100 ppm < 600 ppm < regular < 1,000 ppm |
| 3. nOSA maltodextrin | 100 ppm << 600 ppm < 1,000 ppm < regular |
| 4. carboxymethylcellulose | 100 ppm < 600 ppm < 1,000 ppm << regular |

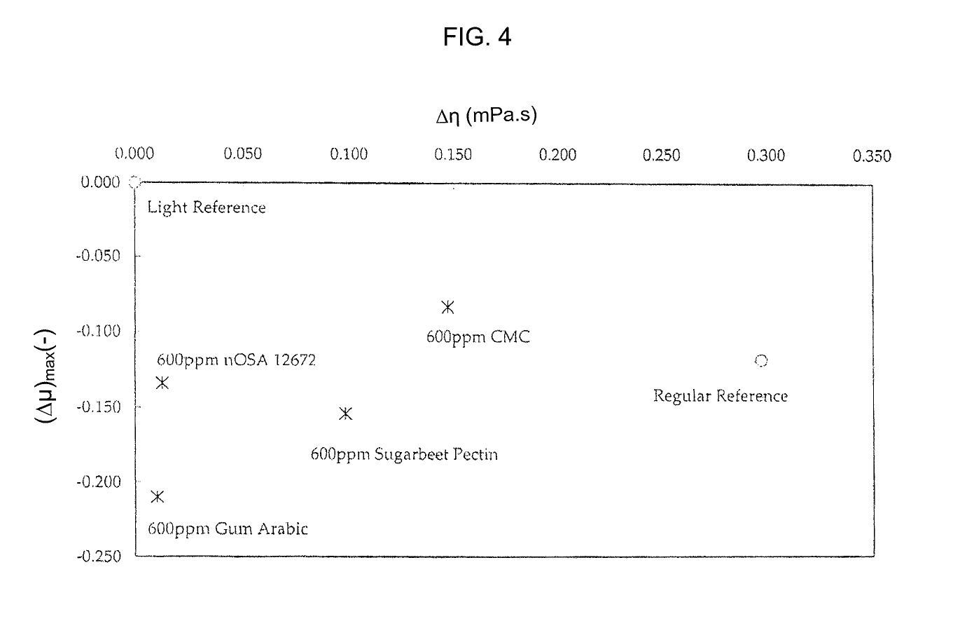

FIG. 4 show the effect of 600 ppm hydrocolloid addition on viscosity and friction versus light reference. The potency of sugar beet pectin for mouthfeel perception is due to a combination of predominantly its lubrication properties and to a lower extent, its viscosity properties.

Although 600 ppm sugarbeet pectin can provide a mouthfeel perception equivalent to the regular beverage, FIG. 4 show that there is still a gap in viscosity compared to the regular beverage. It is therefore recommended to fill the gap with a hydrocolloid or a bulking agent having a low impact on lubrication, filling this gap is improving the body of the beverage.

### Example 2

### Fanta® Type Carbonated Beverages

### 2.1 Composition of Fanta® Type Carbonated Beverages

The Fanta® type carbonated beverages have the following composition:

Regular beverage: carbonated water, sugar, orange juice from concentrate, acidity regulator E330 (citric acid), aromas, preserver E211 (sodiumbenzoate), stabilizer E412 (guar gum), antioxidant E300 (ascorbic acid).

9% sugar added

Light beverage: carbonated water, orange juice from concentrate, acidity regulator E330 (citric acid), Tested ingredient, high intensity sweeteners (acesulfame K, Aspartame), aromas, preserver E211 (sodiumbenzoate),

0% sugar added
2.2 Sensory Analysis (mouthfeel), Rheology & Tribology of Fanta® Type Carbonated Beverages

Similar to example 1 part 1.5, Fanta® type carbonated beverages were prepared with hydrocolloids levels of 100, 600 and 1,000 ppm.

Table 3 tabulates sensory scores of the beverages ranking the hydrocolloids by potency for mouthfeel perception.

TABLE 3
Sensory analysis mouthfeel data

| Hydrocolloids potency | Sensory Score (ranking) |
|---|---|
| 1. Sugarbeet Pectin | 100 ppm < 600 ppm ~ regular < 1,000 ppm |
| 2. Gum Arabic | 100 ppm < 600 ppm < regular < 1,000 ppm |
| 3. nOSA maltodextrin | 100 ppm < 600 ppm < 1,000 ppm < regular |
| 4. carboxymethylcellulose | 100 ppm < 600 ppm < 1,000 ppm << regular |

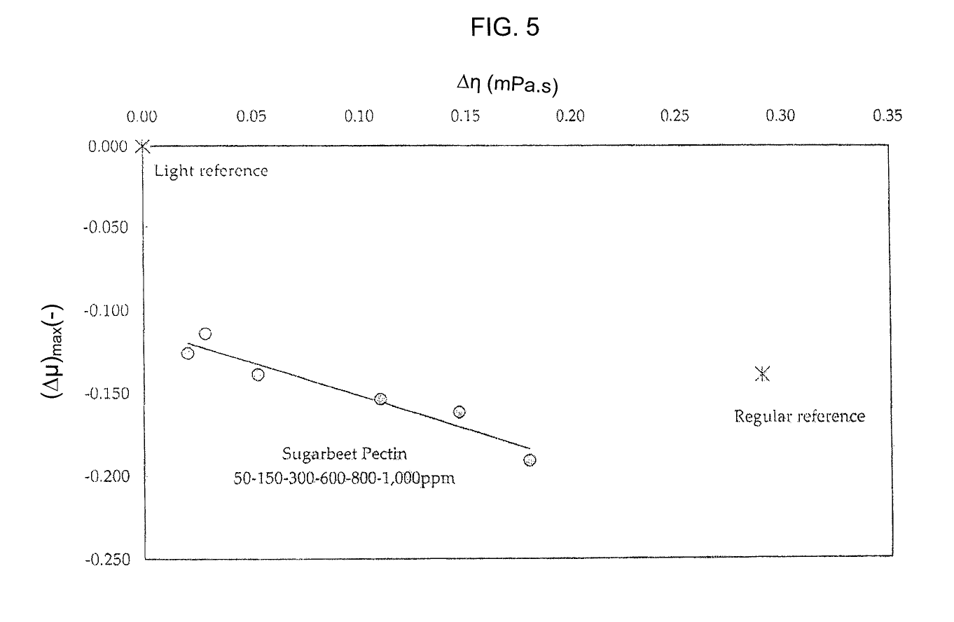

FIG. 5 show the effect of 50 to 1,000 ppm sugarbeet pectin addition on viscosity and friction versus light reference. It is confirmed that the potency of sugarbeet pectin for mouthfeel perception is due to predominantly its lubrication properties and to a lower extent, its viscosity properties.

### Example 3

### Influence of Sugar Beet Pectin on the Tribological Properties of Light Soft Drinks

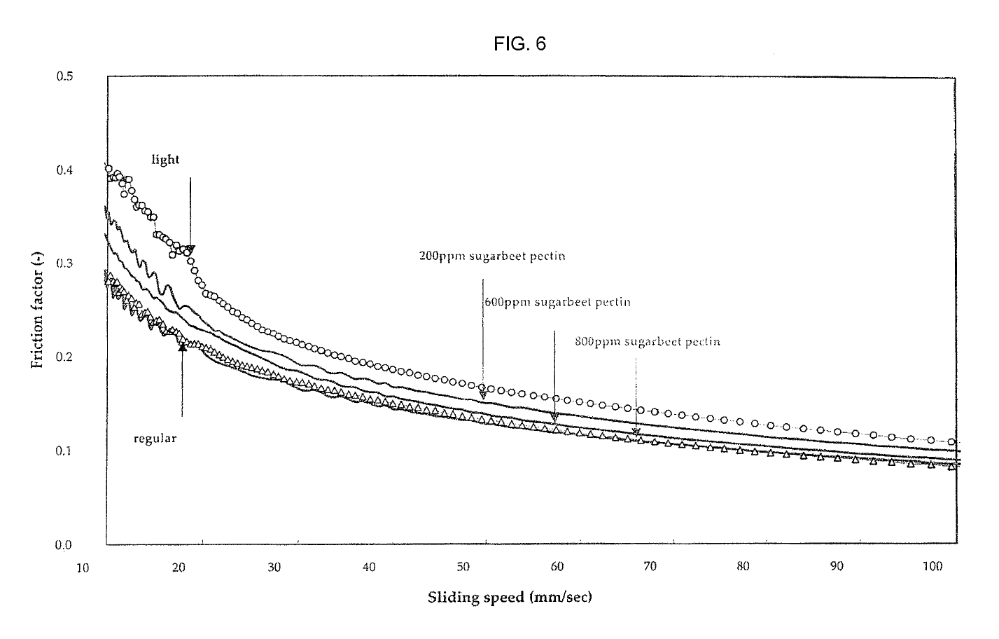

Degassed mixtures of Fanta®, Fanta Light® and Fanta Light with increasing concentrations of sugar beet pectin were examined by rheological measurements, tribological measurements and a test panel assessing the sensory mouthfeel of these compositions. The results are summarized in Table 4 below. The tribological data are also depicted in FIG. 6.

TABLE 4

| | Sugar beet | | Friction | |
|---|---|---|---|---|
| | pectin | Capillary | factor μ | Sensory |
| | concentration | viscosity | 10-100 mm/sec | mouthfeel |
| Sample name | (ppm, as is) | at 20° C. | at 20° C. | at 20° C. |
| Light | 0 | 1.122 | 0.231 | Empty |
| 200 ppm sugar | 200 | 1.150 | 0.201 | Improved |
| beet pectin | | | | |
| 600 ppm sugar | 600 | 1.210 | 0.187 | High |
| beet pectin | | | | |
| 800 ppm sugar | 800 | 1.244 | 0.169 | Highest |
| beet pectin | | | | |
| Regular | 0 | 1.391 | 0.174 | high |

### Example 4

### Flavoured Water

### 4.1 Preparation of Iso-Viscous Flavoured Water

Ingredients of flavoured water (Vitalinea® Fraise-Framboise, Danone®): spring water (99.7%), acidifiers (citric acid, malic acid), magnesium sulphate, calcium lactate, calcium chloride, aroma, E212 (potassium benzoate), E242 (dimethyl dicarbonate), high intensity sweeteners (acesulfame K, sucralose).

A light and a regular reference were prepared with 3 and 12 g/100 mL sucrose addition. Light flavoured water spiked with hydrocolloids were prepared to achieve the same viscosity as the regular reference (see table 4). The hydrocolloids were allowed to hydrate 1 hour at room temperature under gentle magnetic stirring. The beverages were then stored overnight at 4° C. prior sensory analysis.

### 4.2 Sensory Analysis (Mouthfeel), Rheology & Tribology of Fanta®-Type Carbonated Beverages

### Conditions:

Temperature: 4° C. (after overnight fridge refrigeration)
viscosity (20° C.)=1.009 mPa·s (capillary flow)

### pH (20° C.)=5.7

conductivity (20° C.)=1,490 mS

Sensorial descriptor is mouthfeel sensation. The poor mouthfeel reference is the light beverage (3 g sucrose per 100 ml), the good mouthfeel reference is the regular beverage (12 g sucrose per 100 ml). As shown in the table below, the highest mouthfeel perception was obtained for the flavoured water spiked with sugar beet pectin.

TABLE 5
Sensory Analysis (mouthfeel)

| | | hydrocolloid | | Sensory score |
|---|---|---|---|---|
| | sucrose | (g/100 ml, | ηᵣₑₗ | mouthfeel |
| Beverage | (g/100 ml) | as is) | (calculated) | sensation |
| Light | 3 | — | 1.077 | 1 (low) |
| nOSA | 3 | 1.29 | 1.393 | 2 |
| maltodextrin | | | | |
| C*Form 12672 | | | | |
| (Cargill) | | | | |
| gum arabic | 3 | 1.45 | | 3 |
| Ultra VM | | | | |
| (Caldic | | | | |
| Belgium N.V.) | | | | |
| Regular | 12 | — | | |
| sugar beet | 3 | 0.22 | | 4 (high) |
| pectin | | | | |
| Stal 1493 | | | | |
| (Cargill) | | | | |

### Example 6

### Influence of Citrus Pectin on Bitterness and Astringency

A calorie-reduced beverage was created using rebaudioside A (e.g. TRUVIA™ high intensity sweetener available from Cargill). The sugar content was reduced by about 90% and rebaudioside A was added to replace the sweetness of the sugar. The calorie-reduced beverage lacked mouthfeel and had an increase in astringency and bitterness. Citrus pectin was then added to add back some of the body and mouthfeel that was missing from the removed sugar. In addition to improving mouthfeel, the citrus pectin also reduced the astringency and even masked the inherent bitterness of rebaudioside A. The calorie-reduced beverage tasted like previous diet drinks but with the addition of the citrus pectin the sweetness profile was rounded out, the flavor delivery was improved and the typical diet “bitter aftertaste” was greatly reduced.

Subsequent calorie-reduced beverages have been formulated using other high intensity sweeteners (e.g. aspartame) with similar results and flavor improvements.

### Example 7

### Comparison of a Regular, Calorie-Reduced and Modified Calorie-Reduced Carbonated Lemon Lime Type Beverage

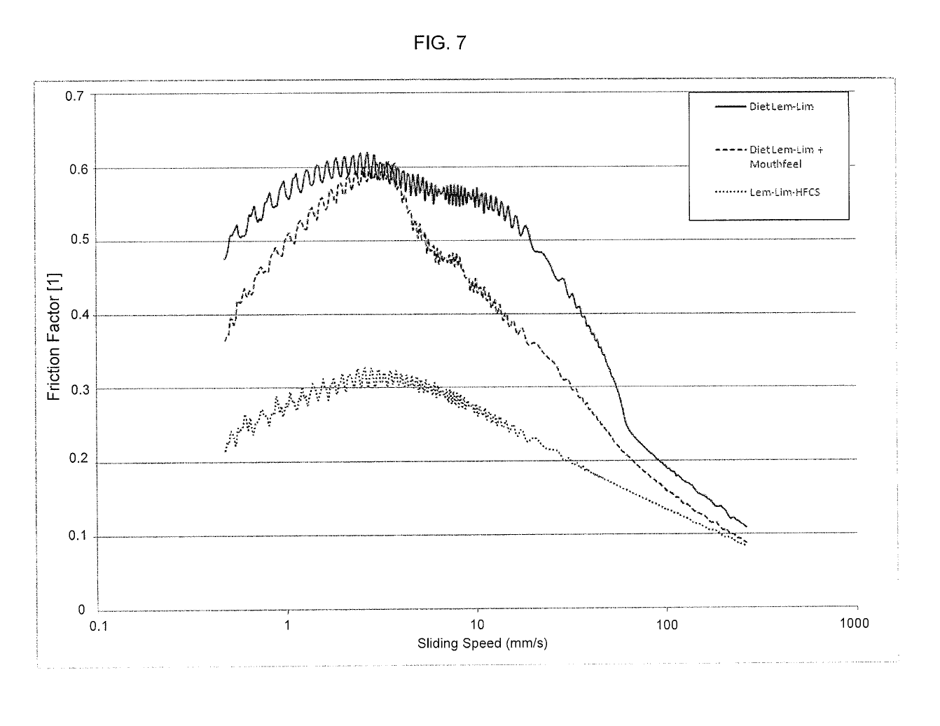

FIG. 7 is a Stribeck curve showing the differences between a full calorie lemon lime type beverage, a calorie-reduced beverage in which rebaudioside A (e.g. TRUVIA™ high intensity sweetener) has been added to address sweetness of the beverage due to the reduction in sugar and a modified calorie-reduced beverage in which both rebaudioside A and citrus pectin have been added to address sweetness and mouthfeel respectively as measured by the Tribometer device discussed previously. The figure demonstrates that the addition of citrus pectin results in a beverage having viscosity and lubrication measurements more like the equivalent full calorie beverage.

### Example 8

### Influence of Citrus Pectin on Bitterness and Astringency

An energy drink was created using rebaudioside A (e.g. TRUVIA™ high intensity sweetener available from Cargill). The energy drink also contained high quantities of a range of B-vitamins. Citrus Pectin was then added at three different levels (i.e. 250, 500 and 700 ppm) to samples of the energy drink. Upon tasting the samples it was noticed that in addition to a reduction in bitterness of rebaudioside A, the vitamin taste was also diminished in proportion to the quantity of pectin. The higher the pectin content, the more the vitamin off-flavors were masked.

### Example 9

### Lemon Lime Soda Formulations

Lemon lime sodas were prepared according to the following formulations:

| Ingredient/Amount | Sample A | Sample B | Sample C |
|---|---|---|---|
| Aspartame | 2.88 | 2.88 | |
| High Fructose Corn Syrup | | | 620.00 |
| Potassium Citrate | 1.56 | 1.56 | 1.56 |
| Citric Acid | 5.90 | 5.90 | 5.90 |
| Natural Lemon Lime Flavor | 3.00 | 3.00 | 3.00 |
| 5% 64365 Solution (Pectin) | | 20.00 | |
| Water | Q.S. to 1000 | Q.S. to 1000 | Q.S. to 1000 |

58.3 grams of each of Samples A, B and C were added to 291.7 grams of carbonated water to form a diet beverage, a diet beverage with pectin and a control beverage respectively. The bottles were each capped and chilled.

The samples were then tasted. The diet beverage had noticeable aspartame aftertaste and bitterness. The diet beverage with pectin tasted like a full sugar version of a lemon lime soda and had reduced aspartame aftertaste compared to the diet beverage. The sweetness of the diet beverage with pectin was also improved and the bitterness was reduced. The control beverage tasted like a full sugar version of a lemon lime soda and was very similar in taste to the diet beverage with pectin.

1. A method for improving the flavor of beverages comprising the step of adding from about 10 to about 1500 ppm of one or more first hydrocolloids to said beverage, wherein the first hydrocolloids have an intrinsic viscosity of 5-600 mL/g as measured by capillary flow viscosimetry.

2. The method according to claim 1, wherein said intrinsic viscosity is from about 10 to about 450 mL/g.

3. The method according to claim 1, wherein said—first hydrocolloids are selected from the group consisting of sugar beet pectin, apple pectin, citrus pectin, gum arabic, nOSA (n-octenyl succinic anhydride) maltodextrin, low molecular weight carboxymethylcellulose and mixtures thereof.

4. The method according to claim 1, further comprising adding one or more edible substances selected from the group of second hydrocolloids, bulking agents or mixtures thereof provided that the other hydrocolloid is different from the first hydrocolloid.

5. The method according to claim 4, wherein:
a) said second hydrocolloids are selected from the group consisting of guar gum, locust bean gum, cassia gum, pectin from botanical sources, high molecular weight carboxymethylcellulose, carrageenan, alginate, xanthane and mixtures thereof,
b) said bulking agents are selected from the group consisting of isomaltulose, polydextrose, trehalose, erythritol or oligodextrans and mixtures thereof.

6. The method according to claim 4, wherein the ratio of first hydrocolloid to edible substance is from about 150:1 to about 1:1200.

7. (canceled)

8. The method according to claim 1, wherein the beverage is a calorie-reduced beverage having a lubricity which is about equal or higher than the lubricity of its equivalent full calorie beverage.

9. The method according to claim 8, wherein said calorie-reduced beverage has a viscosity which is about equal to the viscosity of its equivalent full calorie beverage.

10. The method according to claim 8, wherein said calorie-reduced beverage comprises at least one high intensity sweetener.

11. The method according to claim 8, wherein said calorie-reduced beverage comprises rebaudioside A.

12. The method according to claim 8, wherein the beverage is a calorie-reduced beverage having a sweet flavor, bitter flavor, astringency or combination thereof which is about equal or higher than sweet flavor, bitter flavor, astringency or combination thereof of its equivalent full calorie beverage

13. The method according to claim 1, wherein the beverage is a carbonated or a non-carbonated beverage.

14. The method according to claim 1, wherein said beverage is an alcoholic beverage or a non-alcoholic beverage.

15. A calorie-reduced beverage composition having a sweet flavor, bitter flavor, astringency or combination thereof which is about the same or higher than the sweet flavor, bitter flavor, astringency or combination thereof of its equivalent full calorie beverage, said calorie-reduced beverage composition comprising one or more first hydrocolloids having an intrinsic viscosity of about 5 to about 600 mL/g as measured by capillary flow viscosimetry and at least one high intensity sweetener.

16. A calorie-reduced beverage composition according to claim 15, wherein said intrinsic viscosity is from about 10 to about 450 mL/g.

17. A calorie-reduced beverage composition according to claim 15, wherein said first hydrocolloids are selected from the group consisting of sugar beet pectin, apple pectin, citrus pectin, gum arabic, nOSA (n-octenyl succinic anhydride) maltodextrin, low molecular weight carboxymethylcellulose and mixtures thereof.

18. A calorie-reduced beverage composition according to claim 17 further having a viscosity about equal to or higher than the viscosity of its equivalent full calorie beverage, said calorie-reduced beverage composition comprising one or more edible substances selected from the group of second hydrocolloids, bulking agents or mixtures thereof, provided that the second hydrocolloid is different from the first hydrocolloid.

19. A calorie-reduced beverage composition according to claim 18, wherein
a. said second hydrocolloids are selected from the group consisting of guar gum, locust bean gum, cassia gum, pectin from botanical sources, high molecular weight carboxymethylcellulose, carrageenan, alginate, xanthane and mixtures thereof,
b. said bulking agents are selected from the group consisting of isomaltulose, polydextrose, trehalose, erythritol or oligodextrans and mixtures thereof.

20. A calorie-reduced beverage composition according to claim 18, wherein the ratio of first hydrocolloid to edible substance is from about 150:1 to about 1:1200.

21. A calorie-reduced beverage composition according to claim 15 wherein the at least one high intensity sweetener is rebaudioside A.

22. (canceled)
